(19) United States
(12) Patent Application Publication
(10) Pub. No.: US 2015/0224857 A1
(43) Pub. Date: Aug. 13, 2015

(54) REAR WINDOW SUNSHADE FOR VEHICLE AND METHOD OF OPERATING

(71) Applicants: Craig Calkins, Troy, MI (US); Geoffrey Barr, Troy, MI (US); Jeffrey Laukonis, Macomb, MI (US); Bruce Rokicki, Rochester Hills, MI (US)

(72) Inventors: Craig Calkins, Troy, MI (US); Geoffrey Barr, Troy, MI (US); Jeffrey Laukonis, Macomb, MI (US); Bruce Rokicki, Rochester Hills, MI (US)

(21) Appl. No.: 14/619,607

(22) Filed: Feb. 11, 2015

Related U.S. Application Data
(60) Provisional application No. 61/939,012, filed on Feb. 12, 2014.

(51) Int. Cl. B60J 3/02

(52) U.S. Cl. CPC B60J 3/0278

(57) ABSTRACT

A rear window sunshade for a vehicle is provided. The rear window sunshade having: a frame assembly having a main carrier and a pair of end housings movably attached to opposite ends of the main carrier so that an overall length of the frame assembly can be varied through slidable movement of the pair of end housings with respect to the main carrier; a pair of side guides each being coupled to one of the pair of end housings; and a roller blind operatively coupled to the frame assembly and configured for movement between a stowed position and a deployed position, wherein opposite ends of the roller blind slide within the pair of side guides as the roller blind moves between the stowed and deployed positions.

### CROSS REFERENCE TO RELATED APPLICATIONS

This application claims the benefit of U.S. Provisional Patent Application Ser. No. 61/939,012 filed Feb. 12, 2014, the entire contents of which are incorporated herein by reference thereto.

### BACKGROUND

Various embodiments of the present invention relate to a rear window sunshade and more particularly, a rear window sunshade for a vehicle and method of operating and/or installing.

Most all vehicles have a unique rear design due to the vehicle's rear window geometry. Therefore, any sunshade installed in these vehicles would require vehicle specific tooled components. In addition, these sunshades have large gaps at their sides because the fabric is only constrained on two sides namely the front and back of the sunshade as opposed to its sides.

Accordingly, it is desirable to provide a sunshade that is universally applicable to many different vehicle designs and/or body types. In addition, it is also desirable to provide a sunshade that is secured at its edges in order to prevent light from passing through the sides of the sunshade.

### SUMMARY OF THE INVENTION

In one embodiment, a rear window sunshade is provided. The rear window sunshade having: a frame assembly having a main carrier and a pair of end housings movably attached to opposite ends of the main carrier so that an overall length of the frame assembly can be varied through slidable movement of the pair of end housings with respect to the main carrier; a pair of side guides each being coupled to one of the pair of end housings; and a roller blind operatively coupled to the frame assembly and configured for movement between a stowed position and a deployed position, wherein opposite ends of the roller blind slide within the pair of side guides as the roller blind moves between the stowed and deployed positions.

In another embodiment, a rear window sunshade for a vehicle is provided. The sunshade having: a frame assembly, having: a main carrier; a pair of end housings movably attached to opposite ends of the main carrier so that an overall length of the frame assembly can be varied through slidable movement of the pair of end housings with respect to the main carrier; a pair of side guides each being coupled to one of the pair of end housings, wherein the pair of side guides when secured to the pair of end housings are located adjacent to an opening of a rear window of the vehicle; and a roller blind operatively coupled to the frame assembly and configured for movement between a stowed position and a deployed position, wherein opposite ends of the roller blind slide within the pair of side guides as the roller blind moves between the stowed and deployed positions and wherein the movement of the opposite ends of the roller blind slide outside of a periphery of the opening of the rear window.

### BRIEF DESCRIPTION OF THE DRAWINGS

These and/or other features, aspects, and advantages of the present invention will become better understood when the following detailed description is read with reference to the accompanying drawings in which like characters represent like parts throughout the drawings, wherein:

FIG. 1 is a perspective view of a rear window sunshade installed in a frame of a vehicle;

FIG. 2 is a perspective view of a rear window sunshade according to one embodiment in an expanded or deployed configuration;

FIG. 3 is a perspective view of the rear window sunshade of FIG. 2 in a stowed or unexpanded configuration; and

FIGS. 4 and 5 are exploded views illustrating components of a rear window sunshade in accordance with various embodiments of the present invention;

FIGS. 6 and 7 are views of various components of the rear window sunshade in accordance with various embodiments of the present invention; and

FIGS. 8 and 9 are views of a rear window sunshade in accordance with an alternative embodiment of the present invention.

Although the drawings represent varied embodiments and features of the present invention, the drawings are not necessarily to scale and certain features may be exaggerated in order to illustrate and explain exemplary embodiments the present invention. The exemplification set forth herein illustrates several aspects of the invention, in one form, and such exemplification is not to be construed as limiting the scope of the invention in any manner.

### DETAILED DESCRIPTION

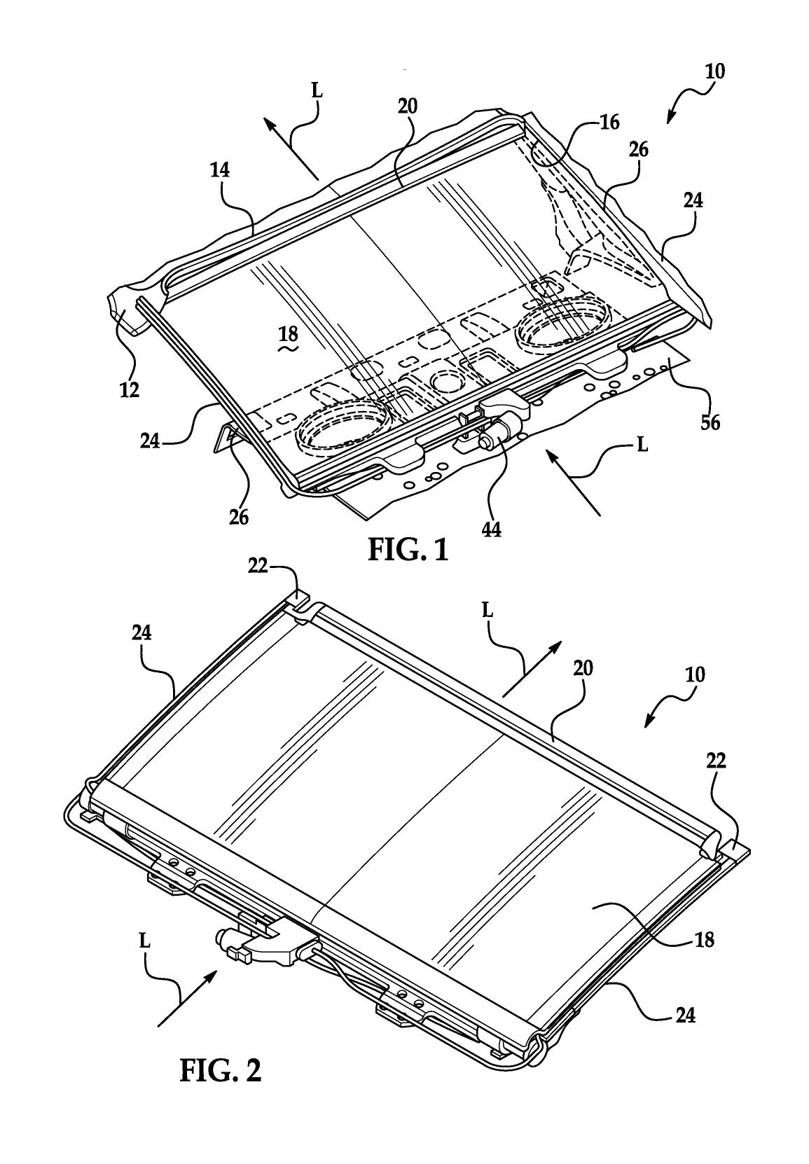

Referring now to the FIGS. and in particular, FIG. 1 a rear window sunshade assembly 10 is illustrated. As shown, a rear portion 12 of an upper vehicle frame 14 is provided with an opening 16. The opening 16 is configured to receive a window therein when the vehicle is assembled.

In accordance with an exemplary embodiment, the opening 16 may be provided with the rear window sunshade assembly 10. The rear sunshade assembly has a roller blind 18 that can be displaced, with respect to the vehicle, forwards (in a longitudinal direction L of the vehicle) and rearwards (counter to the longitudinal direction L of the vehicle), either manually or by being driven by a motor. If the roller blind 18 is pushed toward the rear, the opening 16 is uncovered and sunlight can access the vehicle interior. If on the other hand, the roller blind 18 is pushed forwards the opening 16 become covered by the roller blind 18 and sunlight is blocked or filtered by the material of the roller blind 18.

In one embodiment, the roller blind 18 may be composed of a flexible material, for example a fabric or a plastic film. In order to provide rigidity to the sunshade and in particular the forward end of the roller blind 18, a bow 20 is secured to a front edge of the roller blind 18. In some embodiments, the bow 20 is formed from a more rigid material than the roller blind 18. In the case of manual actuation the bow 20 allows a user to grasp the same and displace the roller blind 18 to the front or rear of the opening (in the longitudinal direction L or counter to the longitudinal direction L). Alternatively and as will be described below, the bow 20 and roller blind 18 may be driven by an electric motor.

In one embodiment, the fabric of the roller blind 18 is formed from a material having an elastic property, which is configured to provide tension in the X direction (as illustrated in FIG. 4). The elasticity may also compensate for tolerances in the parallelism of the side guides 24, or even allow slightly trapezoid layouts of the rear sunshade if the rigid bow 20 at the front edge of the sunshade is eliminated.

In addition, the elastic property of the roller blind will accommodate for curved rear window applications wherein the rear window or opening in the X direction is arcuate or curved in shape (e.g., the midpoint is higher than the end points). Still further this will also allow the roller blind to accommodate for curved side guides 24 that may also be curved to accommodate for curves in the opening or rear window in directions parallel to the “L” direction. These curves in the “X” and/or “L” direction may be combined or comprise standalone features depending on the vehicle configuration.

In addition, the bow 20 may also be curved to accommodate for these curves and the elastic properties of the roller blind material are configured to cooperate with the same by maintaining the roller blind in a state of tension to eliminate sags or folds as the sunshade is deployed along an opening have various curves and/or features. Another, non-limiting application is to employ a fabric for the roller blind 18 that also provides tension in the L direction as well as the X direction or in lieu of X direction. Still further, the fabric may be configured to provide tension in directions that are angularly orientated with respect to the X and/or L directions and as such, multiple combinations are contemplated. As mentioned above, the bow 20 may also be angularly configured and in some embodiments and depending on the configuration of the sunshade it may be eliminated altogether or alternatively may be configured from a material having elastic properties.

The bow 20 is displaceably accommodated in the assembly 10 via a pair of sliders 22 each one of which is slidably received within a guide rail or side guide 24 as well as being secured to the bow 20. The guide rails 24 are located along the laterally spaced edges 26 of the opening 16. The sliders 22 as well as the longitudinal edges of the roller blind 16, (e.g., right and left edges of the roller blind 18, as viewed in the longitudinal direction L of the vehicle), are slidably received within the guide rails 24. In order to allow for the slidable movement of the roller blind 18 as well as the sliders 22, each guide rail 24 has an opening, feature or recess 28 that is configured to slidably receive these portions of the sunshade assembly 10.

In one embodiment, the guide rails 24 may be formed from a material, such as plastic or metal or combination thereof that is fastened to the vehicle. In one embodiment, the rails 24 and the sunshade are secured to the vehicle prior to the application of an interior trim. Attached to each slider 22 is a spring member such as a thin metal or plastic strip 30 that extends over an entire length of the roller blind 18. This strip 30 is configured to wind itself up spirally after it is unwound, which provides a winding-up force for the roller blind 18.

As illustrated in the FIGS. the rear window sunshade assembly 10 or sunshade 10 has a frame assembly 32. Assembly 32 has a main carrier 34 and a pair of end housings 36 slidably attached to opposite ends 38 of the main carrier 34 so that an overall length “x” of the frame assembly 32 can be varied through slidable movement of the pair of end housings 36 with respect to the main carrier 34 in the direction of arrows 40. The movement of the end housings 36 allow the length x of the frame assembly 32 to be varied to adjust the frame assembly 32 to have a length that is adjusted to a corresponding length of a rear window opening in a vehicle. In other words, length x is adjusted so that outermost portions of the end housings are located outside of a periphery of opening 16 so that the edges of the roller blind 18 slide outside of the opening 16. Once adjusted, the end housings 36 are then secured to the vehicle and/or the main carrier 34, which is also secured to the vehicle.

This slidable movement of the edges of the roller blind 18 outside the peripheral edges of the opening 16 prevents sunlight from bleeding through the edges of the roller blind 18 when it is in the deployed position. In order to achieve this, a pair of side guides or guide rails 24 are provided. Each side guide 24 is coupled at one end to one of the pair of end housings 36.

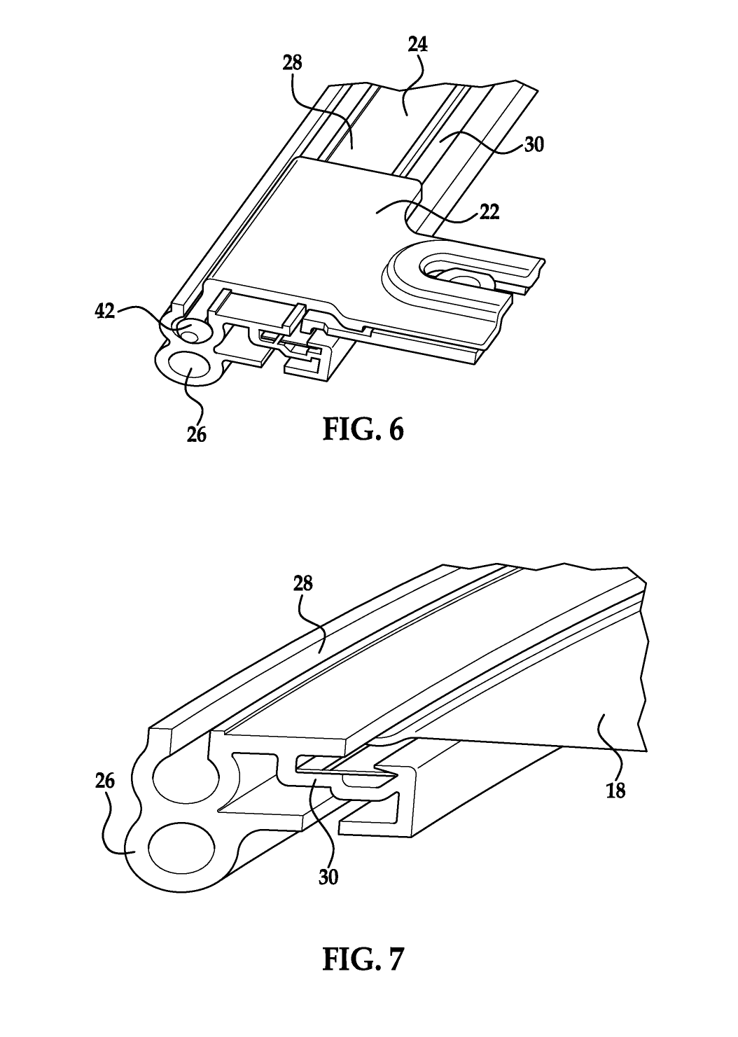

As shown at least in FIGS. 6 and 7, the side guides 24 are configured to slidably receive the spring member 30, the edges of the roller blind 18 secured thereto and the pair of sliders 22. Side guides 24 are formed from an extruded member (e.g., metals, plastics, rubber, alloys or any combination thereof) or a plastic material that is easily formed by any suitable process.

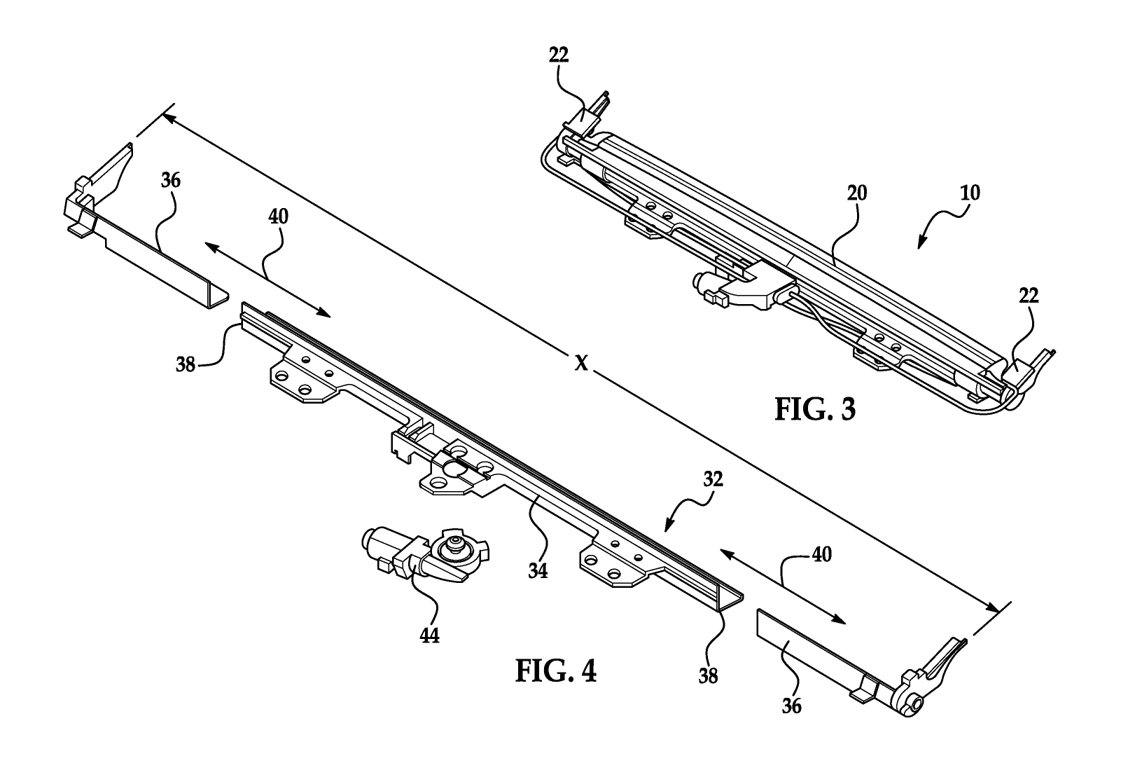

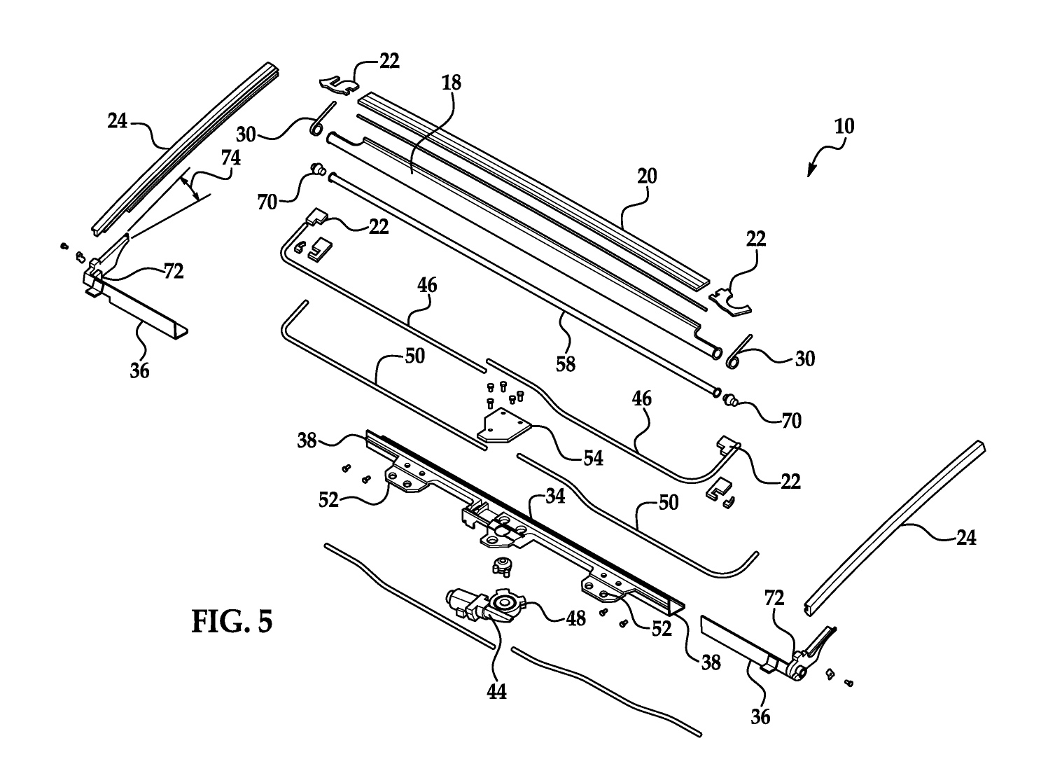

As shown, the roller blind 18 is operatively coupled to the frame assembly 32 and capable of movement between a stowed position (see at least FIG. 3) and a deployed position (see at least FIG. 2), wherein opposite ends of the roller blind slide within the pair of side guides 24 as the roller blind 18 moves between the stowed and deployed positions. In one embodiment, the sliders 22 have a feature 42 configured to be slidably received in opening or recess 28. In one embodiment, sliders 22 are also secured to the bow 20 and are moved in the longitudinal direction “L” via a motor assembly 44 operatively coupled thereto by push/pull cables 46, which are also secured or operatively coupled to the sliders 22. In one embodiment, the push/pull cables 46 are secured to feature 42. During operation of the motor assembly 44, the push/pull cables 46 are translated within tubes or shrouds 50 as a gear output 48 of the motor assembly 44 is actuated. In addition and in some embodiments as the sunshade is deployed and/or stowed, the push/pull cables 46 are slidably received within recesses 28 of the side guides 24 as the sunshade is deployed and stowed by the motor assembly 44. It being understood that the gear output 48 is operatively coupled to the push/pull cables 46 at one end in order to provide the desired movement fore and aft of the sunshade 10 via movement of sliders 22 operatively coupled to an opposite end of the push/pull cables 46 via feature 42 as the motor assembly 44 is energized. As mentioned above, the cables 46 can also be slidably received within cable shrouds 50. In an alternative configuration, the cables 46 are wound and unwound on a spool operatively coupled to the motor assembly 44. In some embodiments, smart electronics and sensors may be employed in the motorized option in order to provide an anti-pinch or automatic reverse feature.

In one embodiment, the main carrier 34 may be molded from plastic and has integral mounting features 52 and a gear housing 54. In some embodiments, the gear housing is configured to receive gear or gear output 48 operatively coupled to the push/pull cables 46 as well as the motor of the motor assembly 44. The mounting features 52 provide a means for securing the main carrier 34 to a rear deck 56 of a vehicle frame.

Also shown is a roller 58 that is rotationally received within the assembly 10 by for example, a pair of end members 70 that are rotationally received within hubs or openings 72 of the end housings 36. As mentioned above, the slidable movement of the end housings 36 with respect to main carrier 34 allows the width “x” of the assembly 10 to be varied which in turn allows the width of the roller 58 and accordingly roller blind 18 to be varied. This allows the assembly 10 to be adjustable with respect to a variety or rear window configurations each having varying lengths in the “x” direction. In some embodiment, the spring member 30 are also configured to be wound onto and unwound from the roller 58.

Also contemplated is that the angular orientation 74 of the end housings 36 with respect to the deck 56 can be varied by for example, providing differently configured end housings 36. In this application, each pair of end housings 36 can have a different angular orientation 74. Accordingly and by repositioning the removable end housings 36 the assembly 10 is capable of being adjustable and can accommodate various rear window angular configurations with respect to deck 56 as inter-changeable end housings 36 are employed.

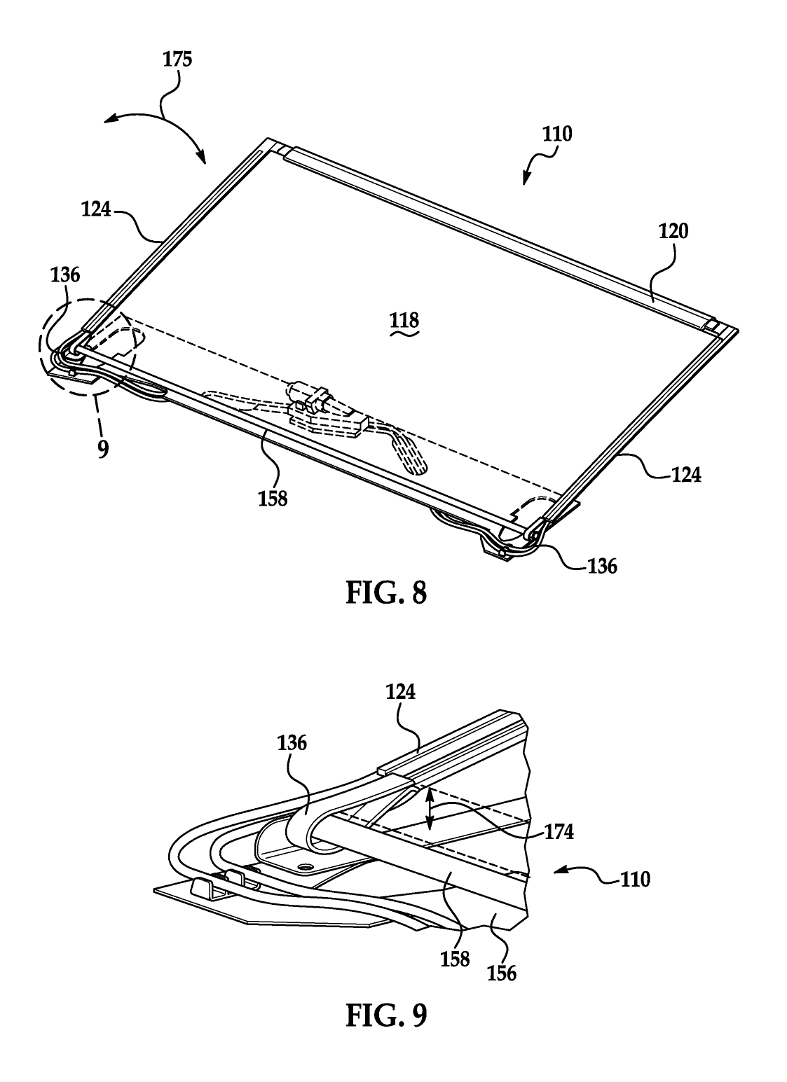

In an alternative embodiment and as illustrated in at least FIGS. 8 and 9 wherein components performing similar or analogous functions are labeled in multiples of 100, a rear window sunshade assembly 110 is able to be oriented or adjusted to correspond to the glass angle of any rear window. In this embodiment, this is achieved by allowing the bearing support or end housings 136 to pivot about a bearing centerline of the roller 158. Accordingly, movement in the directions of arrows 175 is possible in order to vary the angular orientation 174 of the end housings 136 with respect to the deck 156 and thus, the assembly can be used in multiple applications wherein multiple rear window angular orientations are provided.

The embodiments disclosed herein provide numerous advantages non-limiting examples of which are: 1) maximum light blockage by constraining the edges of the roller blind 18 in the guides 24, 124 which are located outside of the periphery of the opening of the rear window; 2) location of the assembly in order to minimize obstruction to a driver rear view sight line; 3) minimize architectural effects to the vehicle by allowing the assembly to be adjustable and hidden under the vehicle trim; 4) a stable guide system; and 5) economic advantages through multiple vehicle platform applications.

In some embodiments, the sunshade is constrained on all four sides in order to minimize light bleed through. This is achieved in one embodiment by gluing or securing metal spring steel strips 30 to the edges of the fabric of the roller blind 18 and guiding it in the same extrusion (e.g., guide or rail 24) as the push cables. This will ensure zero light bleed on the sides of the roller blind 18.

In addition and in some embodiments, the rear window sunshade assembly is configured to accommodate various vehicle configurations either in the “x” direction or window width as well as accommodate for the angular orientation of the rear window the deck 56, 156 which allows applicability to different rear window glass angles.

Accordingly, an electrical powered and/or manually operated automotive rear window sunshade is provided. The sunshade 10, 110 is modular in construction so that it can be used in numerous vehicles having various rear window configurations with minimal changes to the basic construction of the sunshade 10, 110.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A rear window sunshade for a vehicle, comprising:
a frame assembly having a main carrier and a pair of end housings movably attached to opposite ends of the main carrier so that an overall length of the frame assembly can be varied through slidable movement of the pair of end housings with respect to the main carrier;
a pair of side guides each being coupled to one of the pair of end housings; and
a roller blind operatively coupled to the frame assembly and configured for movement between a stowed position and a deployed position, wherein opposite ends of the roller blind slide within the pair of side guides as the roller blind moves between the stowed and deployed positions.

2. The rear window sunshade as in claim 1, further comprising a pair of sliders each being slidably received within one of the pair of side guides.

3. The rear window sunshade as in claim 1, wherein the opposite ends of the roller blind are secured to spring members slidably received within the pair of side guides.

4. The rear window sunshade as in claim 3, wherein the spring members are steel strips slidably received within the pair of side guides.

5. The rear window sunshade as in claim 1, further comprising a bow secured to a forward end of the roller blind.

6. The rear window sunshade as in claim 5, further comprising a pair of sliders each being slidably received within one of the pair of side guides.

7. The rear window sunshade as in claim 6, wherein the opposite ends of the roller blind are secured to spring members slidably received within the pair of side guides.

8. The rear window sunshade as in claim 7, wherein the spring members are steel strips slidably received within the pair of side guides.

9. The rear window sunshade as in claim 1, further comprising a motor assembly configured to move the roller blind between the stowed and deployed positions.

10. The rear window sunshade as in claim 1, wherein the main carrier is molded from plastic and has integral mounting features and a gear housing.

11. The rear window sunshade as in claim 10, further comprising a motor assembly configured to move the roller blind between the stowed and deployed positions, the motor assembly being secured to the main carrier.

12. The rear window sunshade as in claim 1, further comprising: a bow secured to a forward end of the roller blind; a pair of sliders each being slidably received within one of the pair of side guides; and a motor assembly configured to move the roller blind between the stowed and deployed positions through actuation of a cable operatively coupled to the pair of sliders and the motor assembly.

13. The rear window sunshade as in claim 12, wherein the cable is slidably received within the pair of side guides.

14. The rear window sunshade as in claim 13, wherein the opposite ends of the roller blind are secured to spring members slidably received within the pair of side guides.

15. The rear window sunshade as in claim 14, wherein the spring members are steel strips slidably received within the pair of side guides.

16. The rear window sunshade as in claim 15, wherein the main carrier is molded from plastic and has integral mounting features.

17. A rear window sunshade for a vehicle, comprising:
a frame assembly, comprising:
a main carrier;
a pair of end housings movably attached to opposite ends of the main carrier so that an overall length of the frame assembly can be varied through slidable movement of the pair of end housings with respect to the main carrier;
a pair of side guides each being coupled to one of the pair of end housings, wherein the pair of side guides when secured to the pair of end housings are located adjacent to an opening of a rear window of the vehicle; and
a roller blind operatively coupled to the frame assembly and configured for movement between a stowed position and a deployed position, wherein opposite ends of the roller blind slide within the pair of side guides as the roller blind moves between the stowed and deployed positions and wherein the movement of the opposite ends of the roller blind slide outside of a periphery of the opening of the rear window.

18. The rear window sunshade as in claim 17, further comprising a pair of sliders each being slidably received within one of the pair of side guides.

19. The rear window sunshade as in claim 18, wherein the opposite ends of the roller blind are secured to spring members slidably received within the pair of side guides.

20. The rear window sunshade as in claim 19, wherein the spring members are steel strips slidably received within the pair of side guides and the sunshade further comprises a motor assembly configured to move the roller blind between the stowed and deployed positions, the motor assembly being secured to the main carrier.
